(19) United States
(12) Patent Application Publication
(10) Pub. No.: US 2025/0327743 A1
(43) Pub. Date: Oct. 23, 2025

(54) METHOD AND SYSTEM FOR IDENTIFICATION AND QUANTIFICATION OF SILOXANES IN GASEOUS STREAM

(71) Applicant: Martin L. Spartz, Ellington, CT (US)

(72) Inventor: Martin L. Spartz, Ellington, CT (US)

(21) Appl. No.: 19/173,015

(22) Filed: Apr. 8, 2025

Related U.S. Application Data
(60) Provisional application No. 63/637,612, filed on Apr. 23, 2024.

(51) Int. Cl. G01N 21/3504; G01N 21/35

(52) U.S. Cl. CPC G01N 21/3504; G01N 2021/3595

(57) ABSTRACT

A method and system identify and quantify siloxanes in a gaseous stream by first removing water-soluble interferants, such as oxygenated volatile organic compounds (VOCs), through an aqueous scrubber. The scrubbed gas, which retains siloxanes but is largely stripped of interfering species, is then passed to an absorption spectrometer, for example an FTIR device, where its infrared spectrum is measured. In some embodiments, a portion of the scrubbed gas is further oxidized to remove siloxanes, generating a reference spectrum used to differentiate remaining background signals. A computer manages gas flow among the scrubber, the oxidizer, and the spectrometer, and processes the spectral data using a regression analysis. This approach enables accurate real-time or near-real-time detection of individual siloxane species at low concentrations and improves the reliability of energy systems, such as biogas engines and turbines, by facilitating targeted siloxane monitoring and reducing maintenance due to silica deposits.

### RELATED APPLICATIONS

This application claims the benefit under 35 USC 119(e) of U.S. Provisional Application No. 63/637,612, filed on Apr. 23, 2024, which is incorporated herein by reference in its entirety.

### BACKGROUND OF THE INVENTION

Siloxanes in biogas present a significant challenge for biogas utilization, particularly when the biogas is used as a fuel for energy generation. Siloxanes are silicon-oxygen compounds commonly found in household and industrial products such as cosmetics, shampoos, detergents, and in industrial processes. They can enter the biogas stream through the decomposition of these products in anaerobic digestion facilities, which process organic waste into biogas. The presence of siloxanes in biogas creates several problems. When biogas containing siloxanes is combusted in engines, turbines, or other energy conversion devices, the siloxanes are converted into silicon dioxide (SiO₂) and a fine silica dust. This dust can deposit on engine and turbine components, leading to abrasion, increased wear, and eventual failure of moving parts. Siloxanes can also poison catalysts used in processes to upgrade biogas to biomethane or in emissions control systems. The silica deposits can cover the catalytic surface, greatly reducing its effectiveness and leading to increased emissions or the need for frequent and costly catalyst replacement. Silicon dioxide deposits can also accumulate on the surfaces of heat exchangers, reducing their thermal efficiency. This necessitates increased maintenance to clean and restore heat transfer efficiency. The accumulation of silica deposits from the combustion of siloxanes requires more frequent maintenance and replacement of affected components. This increases the operational costs associated with using biogas as a fuel source. The build-up of silica on combustion and heat transfer surfaces can reduce the overall efficiency of energy conversion systems. This results in lower power outputs and increased fuel consumption to achieve the same energy production levels.

To mitigate these problems, it is necessary to implement siloxane removal techniques as part of the biogas purification process. Techniques such as adsorption (using activated carbon or silica gel), refrigeration, and absorption can be effective in reducing siloxane concentrations in biogas to acceptable levels for combustion or grid injection. However, these techniques add complexity and cost to biogas processing infrastructure, making the efficient removal of siloxanes a key challenge in the wider adoption of biogas as a sustainable energy source.

Siloxane compounds have been measured using Fourier Transform Infrared (FTIR) spectrometry, as discussed by Phillips et al., “Method and Apparatus for Siloxane Measurements in a Biogas”, U.S. Pat. No. 8,462,347 B2. However, one disadvantage of this detection technique is that, since there is no separation of the gaseous components, all of the gaseous constituents have to be measured simultaneously by FTIR. This leads to significant errors due to background absorption of unwanted species. Oxygenated volatile organic compounds (VOCs) tend to be the most problematic since they absorb in the same part of the “fingerprint” region as siloxanes. Compounds, alcohols, aldehydes, ketones, esters and acids all overlap spectrally and all are often present in biogas. In addition, since the various siloxane species have very similar infrared (IR) absorption features, it is impossible to effectively analyze each component separately via classical least squares and present a valid analytical number for each.

Phillips et al. proposed a surrogate analysis technique, where classes of siloxanes (linear or ring structures) were characterized by one or two members of each class. Even so, the detection limit was only about 200 parts-per-billion (ppb) due to signal-to-background limitations from imperfect fitting of the classical least squared spectral signatures of the background gases.

More recently Spartz, et al., “Method for identification and quantification of siloxanes in gaseous stream,” U.S. Pat. No. 11,029,292 B2, proposed a system using thermal desorption tubes and FTIR spectrometers with possibly intervening gas chromatography systems. The described method for detecting siloxanes includes collecting a sample in a thermal desorption tube; desorbing siloxanes from the thermal desorption tube; optionally separating the siloxanes by gas chromatography; and analyzing the desorbed siloxanes or the siloxanes separated by gas chromatography with a Fourier Transform Infrared Spectrometry system.

### SUMMARY OF THE INVENTION

A need exists for improved techniques that address the challenges of identifying and/or quantifying siloxanes and/or the species thereof in gaseous streams. In particular, there is a need for a system configured to remove interferences and detect siloxanes using absorption spectrometry. One embodiment of such a system includes a scrubber configured to remove water-soluble interferants from the gaseous stream, an spectrometer, for example an optical absorption spectrometer, configured to measure absorption, for example infrared, spectra of both the gaseous stream and the scrubbed gaseous stream, and a computer configured to receive data from the absorption spectrometer and determine a concentration of one or more siloxane compounds or siloxanes in general within the gaseous stream.

In some implementations, the absorption spectrometer is a Fourier Transform Infrared (FTIR) spectrometer, allowing for highly sensitive and selective measurements over relevant infrared wavelengths.

To further enhance siloxane detection and address other potential interferences, the system can include an oxidizer for oxidizing and/or adsorber for trapping the siloxane compounds in the gaseous stream prior to analysis by the absorption spectrometer. In certain examples, the oxidizer includes a heated metal oxide catalyst configured to decompose or oxidize siloxanes and other hydrocarbons, thereby generating a reference or background spectrum that substantially lacks siloxanes. This reference spectrum can be compared with the scrubbed sample spectrum to isolate siloxane signals during a subsequent computational analysis.

The scrubber may take various forms suitable for water-based separation of oxygenated volatile organic compounds. For example, the scrubber can include a gas sparge into an aqueous solution, in which the gaseous stream is bubbled through water or another aqueous medium to remove interfering species that overlap spectrally with siloxanes. In addition, some embodiments may further comprise a chiller to remove water vapor that has been added by the scrubber, thus stabilizing moisture content prior to the infrared measurement and simplifying downstream data analysis.

In another aspect, the invention features a system for characterizing and/or quantifying siloxanes using an infrared absorption technique, comprising: an aqueous scrubber that receives a raw gaseous stream and selectively removes interfering species, a gas cell configured to house the gas output from the scrubber, an infrared spectrometer arranged to obtain spectral measurements from the gas cell, and a computer programmed to execute a regression analysis using a reference spectrum and a measured spectrum to derive concentrations of one or more siloxane compounds.

The invention further includes a method for detecting siloxanes in a gaseous stream, in which water-soluble interferants are removed from the gaseous stream by contacting the stream with an aqueous medium, and then an infrared absorption spectrum of the aqueous-scrubbed gaseous stream is measured to determine the presence of one or more siloxane compounds. In certain implementations, the biogas is measured directly, modified by passing it through the aqueous scrubber to remove VOCs, and possibly further modified by passing it through an oxidizer such as a heated metal oxide catalyst and/or adsorber, (e.g., activated carbon) to remove siloxanes, with all resulting spectra-along with the infrared calibration spectra for siloxanes and possibly each siloxane-being utilized to build a regression analysis that determines the concentration of each siloxane or siloxanes in general.

In such a workflow, the initially modified biogas stream (by aqueous scrubbing) becomes the sample, because it retains siloxanes, methane, and water; the twice modified biogas stream (scrubbed and oxidized) becomes the interference spectrum, since it should contain the same amount of methane and water but no siloxanes. If the water-to-methane ratio were to change, a water calibration spectrum can also be generated, for example by running nitrogen (N₂) through the scrubber and collecting that spectrum. Finally, the raw sample biogas stream is utilized by the data-analysis algorithm to remove any remaining interfering species in the quantitative spectral region, thus increasing accuracy for siloxane detection and quantification.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIGS. 1A and 1B are a schematic diagrams showing different apparatus for sample analysis according to embodiments of the present invention; and

FIG. 2 is a flow diagram showing an analysis method.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Also, all conjunctions used are to be understood in the most inclusive sense possible. Thus, the word “or” should be understood as having the definition of a logical “or” rather than that of a logical “exclusive or” unless the context clearly necessitates otherwise. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

It will be understood that although terms such as “first” and “second”, etc. are used herein to describe various elements and/or steps, these elements should not be limited by these terms. These terms are only used to distinguish one element from another element. Thus, an element or step discussed below could be termed a second element or step, and similarly, a second element or step may be termed a first element or step without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments of the present invention are designed to analyze a siloxane-containing sample by first scrubbing the gas of water-soluble interferants.

The individual siloxane components are then detected via spectroscopy such as absorption spectroscopy using for example an FTIR. The siloxane-containing sample can be obtained from a gaseous stream by a sampling pump or other suitable means.

In general, siloxanes are thought of and defined herein as compounds having a molecular structure based on a chain of alternating silicon and oxygen atoms, having, for example, organic groups attached to the silicon atoms. Linear or cyclic, siloxanes often are present as an impurity in industrial or other fluid streams.

One specific example are the biogas streams from wastewater and landfills. Examples of siloxanes that can be encountered in biogas streams include but are not limited to: hexamethyldisiloxane (L2); octamethyltrisiloxane (L3); decamethyltetrasiloxane (L4); hexamethylcyclotrisiloxane (D3);

octamethylcyclotetrasiloxane (D4); decamethylcyclopentasiloxane (D5); dodecamethylcyclohexasiloxane (D6).

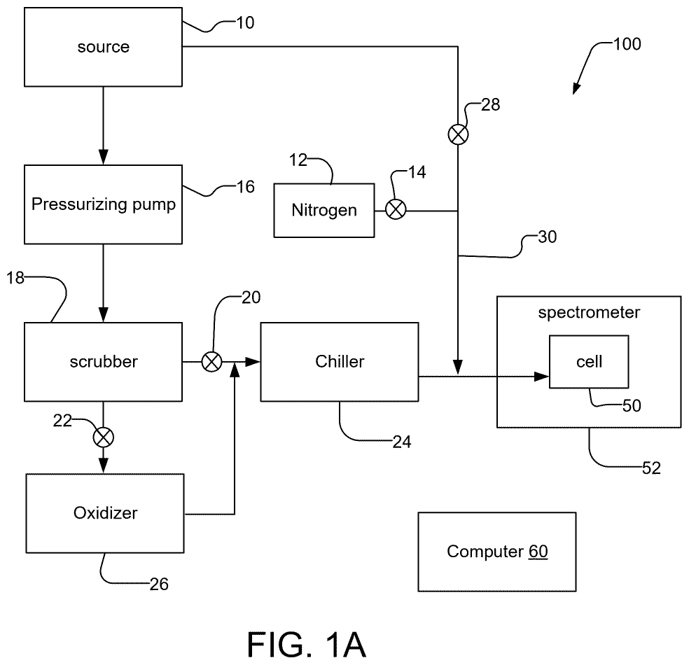

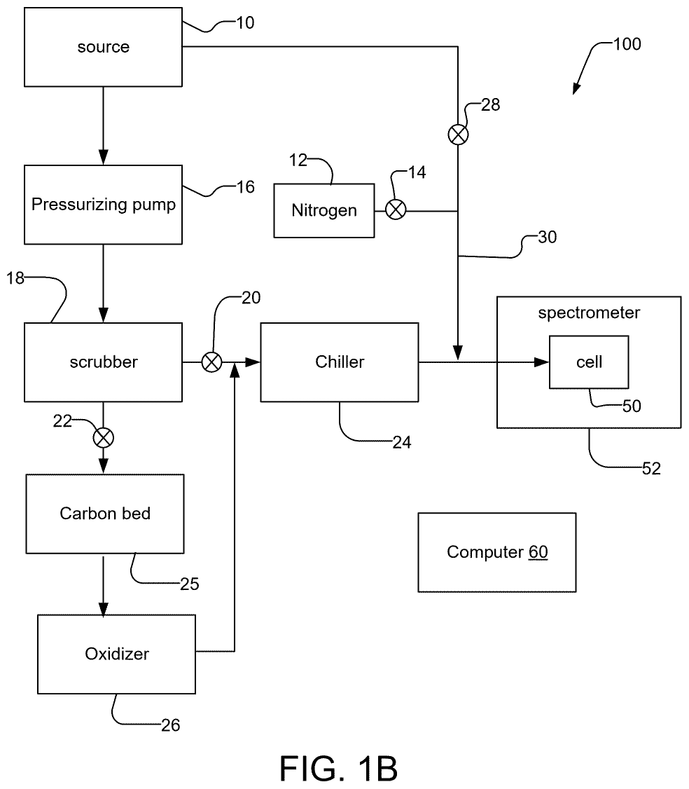

FIG. 1A is a schematic diagram showing one embodiment of a system 100 for measuring and monitoring a siloxane-containing sample.

The system generally functions by selectively scrubbing and/or oxidizing and then detecting various components in the sample. The system 100 includes pressurizing pump 16, scrubber 18 for receiving the sample from the pressurizing pump 16, an oxidizer 26 downstream of the scrubber 16, a chiller 24 for receiving gas directly from either the scrubber 18 or the oxidizer 26. A spectrometer 52, such an absorption spectrometer (e.g., FTIR) with a sample cell 50, collects spectra of the gas in the cell, which are then reported to a computer 60. A nitrogen 12 or other calibration gas source is used that goes directly to the FTIR and bypasses the rest of the system for obtaining a background.

Alternatively to Fourier Transform Infrared (FTIR) spectroscopy, several other absorption spectrometer technologies can be employed, each offering unique advantages. Tunable Diode Laser Absorption Spectroscopy (TDLAS) utilizes tunable diode lasers to measure specific gas concentrations with high sensitivity, making it particularly effective for trace gas detection. Cavity Ring-Down Spectroscopy (CRDS) employs a high-finesse optical cavity to achieve long effective path lengths, enhancing sensitivity for detecting low-concentration species. Incoherent Broad-Band Cavity-Enhanced Absorption Spectroscopy (IBBCEAS) uses broadband light sources and optical cavities to measure absorption spectra, offering high sensitivity across a wide spectral range. Vernier Spectroscopy combines frequency comb lasers with optical cavities to achieve high-resolution, broadband absorption measurements, beneficial for trace gas analysis. These techniques can provide various benefits over FTIR, such as enhanced sensitivity, higher resolution, and the capability to analyze specific sample types or conditions.

Several valves or other gas control mechanisms 14, 20, 22, and 28 under the control of the computer 60 are used to control the gas movement through the system. A first gas controller 14 is provided for the nitrogen 12. A second gas controller 20 and a third gas controller 22 control whether the gas from the scrubber 18 is directly sent or gas from the oxidizer 26 is provided to the sample cell 50 after passing through the chiller 24. A fourth gas controller 28 enables bypass of the scrubber to send the sample directly to the cell 50.

The sample cell 50 is often provided, for example, with windows made of BaF₂, ZnSe, or another suitable material. The cell can be configured for multiple-path (also known as multiple-pass or long path) absorption. The cell could also be a simple linear gas cell. In general, the system should either have a longer gas cell pathlength and/or operate at a higher pressure. For example, 1 meter cell at 10 atmospheres (atm) is the equivalent of 10 meter cell operating at ambient pressure. Operating at pressure has the additional advantage of lowering moisture in the sample in the cell 50. In one example, a 1 meter, down and back cell is used that is able to handle pressure. Such a cell would require little maintenance and may not even need gold coatings.

It should be noted that some embodiments operate at lower pressures such as ambient pressure. In such implementations, the pressurizing pump 16 is not used. In addition, in these various embodiments, the one or more valve based gas control mechanisms 14, 20, 22, 28 would be replaced with pumps or other suitable devices.

In addition, in some examples, the gas cell 50 will be held at a slightly lower pressure than the pressures in the scrubber 18, oxidizer 26, and chiller 24. This provides a slight pressure drop into the cell 50. Also, the gas cell 50 is preferably heated under the control of the computer 60 to prevent condensation of the water.

Since the biogas sample will often be pressurized in the source, it will limit the water content and usually make it constant (for easy spectral removal). A short (down and back) gas cell concept will allow for a low cost cell that does not require regular maintenance and the water absorption will not be too intense.

So, the water scrubber 18 is under pressure as the gas goes through it. The oxygenated VOCs get scrubbed and the siloxanes move through. The chiller may thus not be necessary since as the gas is pressurized it maintains the moisture at a constant level.

Generally, the spectrometer 52 covers at least the “fingerprint” region, given the interest in siloxanes, 7.5 to 12.5 micrometers of wavelength, for resolving the absorption spectra within this band or portions thereof.

The oxidizer 26, such as a heated metal oxide catalyst, removes the oxygenated VOCs and/or the siloxanes by heating the gas to a temperature at which the oxygenated VOCs and/or the siloxanes and other hydrocarbon compounds decompose. This will provide spectra that are be utilized in a regression analysis.

In one example, the scrubber 18 is a packed bed water scrubber. Such devices are a specific type of gas cleaning system used to remove various pollutants, including particulate matter and soluble gases, from gas streams. Oxygenated VOCs are the primary target for removal via water scrubbing.

In another example, the scrubber 18 includes a bubbler through a glass frit to create large numbers of small bubbles that pass through a solution of water. Such as device is easy to operate and can be cleaned and new water added.

In another example, the scrubber includes a vertical column (scrubber) filled with packing material, which provides a large surface area for the gas-liquid interaction. The design and operation involve several key components and steps: The gas stream is introduced at the bottom of the scrubber column. As the gas rises, it comes into contact with a scrubbing liquid (water, in this case) that flows downward. The column is filled with packing material, such as rings, saddles, or structured packing, which increases the contact surface area between the gas and the liquid, enhancing the mass transfer efficiency. The packing material also helps to distribute the liquid evenly across the column. Water can be sprayed from the top of the column and flows downward through the packing material. As it does so, it absorbs soluble gases from the rising gas stream based on their solubility.

The cleaned gas, now with a reduced concentration of oxygenated VOCs and possibly other soluble organic compounds, exits from the top of the scrubber.

Solubility of gases in liquids generally increases with pressure. By pressurizing the gas stream before it enters the water scrubber, VOCs solubility in water is enhanced. This is based on Henry's Law, which states that the solubility of a gas in a liquid at a constant temperature is directly proportional to the pressure of the gas above the liquid.

Lowering the temperature of the gas and the water in the scrubber can also increase solubility. This is because the solubility of gases in liquids typically increases as the temperature decreases (up to a point). Cooling the gas stream and the scrubbing water can be an effective way to enhance methane removal.

Although water is the primary scrubbing medium in packed bed water scrubbers, the introduction of physical solvents that have a higher solubility for oxygenated VOCs are employed in some implementations. These solvents can be mixed with water or used in a separate absorption column designed for VOC removal. Physical solvents like methanol, ethanol, or glycols have higher solubility for than water and could be used to pretreat the gas stream to remove VOCs more effectively. However, this approach shifts the process away from being purely water-based and introduces additional complexity and cost related to solvent recovery and management.

In some examples, the pH or ionic strength of the water in the scrubber 18 is changed or other non-siloxane materials added to help solubilize the oxygenated VOCs. Ideally, the computer 60 controls the process and monitors the process continuously for siloxanes. Thus, this design would allow siloxanes to be monitored minute by minute.

The water vapor added by scrubber 18 is then removed by the chiller 24.

Finally, the gas is analyzed in an absorption spectrometer 52 such as an FTIR spectrometer 52.

FIG. 1B shows another embodiment in which a carbon bed 25 is added before the oxidizer.

As described previously, siloxanes are removed when they go through the thermal oxidizer 26 catalyst.

A problem arises that the siloxanes break down and the remaining silicon is stored in the oxidizer 26. But, the siloxanes will breakthrough when they are at high levels. The solution then is to put an oxidizer catalyst 26 after a carbon bed 25, so only the remaining breakthrough siloxanes are removed from the biogas/biomethane. That way the catalyst 26 lasts longer. This extends the period before the catalyst must be sent back to the factory for reclamation of the expensive metals or rejuvenation of the catalyst.

Specifically, the carbon bed 25 removes siloxanes from biogas through adsorption, where siloxane molecules adhere to the surface of activated carbon. The carbon's high surface area and porous structure effectively trap these contaminants as biogas flows through it. Specialized forms of activated carbon, such as polymorphous porous graphite (PPG), are often used to enhance adsorption efficiency.

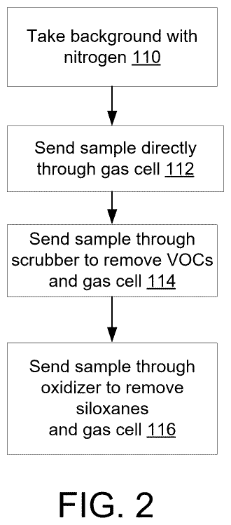

FIG. 2 is a flow diagram showing a process for analyzing the sample under the control of the computer 60.

A spectral background is taken sending nitrogen 12 to the gas cell 50 by control of the gas control mechanism 28 in step 110 to send the nitrogen directly to the gas cell 50. This nitrogen can be pressurized or not. This provides the computer 60 with a background spectrum.

Then, the sample from the source 10 is passed directly to the gas cell 50 by control of the gas control mechanism 28 using line 30 in step 112. Again, this could be pressurized or not, depending on the implementation. The spectrum that is obtained by the computer 60 is used in the regression analysis (it is not the sample) to correct for any remaining VOCs that are interfering with the siloxanes. Generally, the regression coefficient is a 1 or 2% (0.01 or 0.02).

A raw sample is run through the scrubber 18, again either at pressure or not, and to the cell 50 in step 114. This removes the oxygenated VOCs (that interfere most strongly with the siloxanes). This is the “Sample” that is used by the computer 60 to analyze for the presence of siloxanes.

In step 116, the sample is then passed through the carbon bed 25 and/or oxidizer 26, again either at pressure or not. This removes the siloxanes. Then this is passed to the gas cell 50 for measurement. This spectrum is utilized by the computer 60 in the regression analysis to determine the siloxanes in the sample above.

It should be noted that the order is not critical and this can be changed. For instance, this spectrum could be collected first and it is added to the regression. Then the sample is run just through scrubber-no oxidizer and the computer 60 analyzes for the concentration of the siloxanes.

The regression analysis employed by the computer 60 is the following in one example:

D4 Siloxane—Coefficient (usually small since ppb levels and calibration levels are ppm, ˜0.001), or other Siloxane, (such as L3, D3, etc).

The Interference spectrum obtained in step 116 (through scrubber and oxidizer)—Coefficient (normally pretty large, close to 1, example 0.98 or 0.99). This handles the water and methane portion of the sample spectrum.

The Raw Sample obtained in step 112 (straight to the gas cell)—Coefficient (normally very small, hopefully less than 0.01 or 1%). This removes the remaining VOCs.

Methane and/or Water Calibration spectra could also be used to reduce errors in the analysis—Coefficients (should again be small 0.01 to 0.05).

An “idealized regression analysis” would be just the Siloxane and the Interference Spectrum. Since that should be the only things in the “sample spectrum” if the VOCs are properly removed.

If the water to methane ratio were to change, it is usually required to take a water calibration spectrum as well. That could be generated by running nitrogen through the scrubber and collecting that spectrum.

In summary, the biogas is measured directly. The biogas is also modified by passing through aqueous scrubber to remove VOCs. And, the biogas is modified further by passing through a carbon bed and/or heated metal oxide catalyst, in some examples. These spectra along with the infrared calibration spectra for each siloxane is utilized to build a regression analysis to determine the concentration of each siloxane by the computer 60.

The initially modified biogas stream (by aqueous scrubbing) becomes the sample. Since it contains siloxanes, methane and water. The twice modified biogas stream becomes the interference spectra, since it should contain the same amount of methane and water but no siloxanes.

Note that if the water to methane ratio were to change, a water calibration spectrum as well is utilized by the computer 60. That could be generated by running N₂ through the scrubber and collecting that spectrum.

The raw sample biogas stream is utilized by the computer 60 to remove any remaining interfering species in the quantitative spectral region.

This technique can be applied to measuring siloxanes in biogas streams, such that wastewater and landfill operators can get near-real time concentration profiles of siloxanes which may be coming through their filter media. This will allow the filter process to be stopped, saving any unwanted siloxanes from being burnt in the cogeneration engines or turbines, which could destroy either by abrasion of moving parts from the resultant silicates (“sand”). The detection of siloxanes is critical to the wastewater and landfill biogas operations, since excess siloxanes that are burnt during the combustion process to generate electricity through either reciprocation internal combustion engines (RICE) or microturbines can easily penetrate the pistons, bearings and oils used in these machines and abrade these parts, causing irreparable harm and requiring complete overhaul—leading to downtime. Examples of siloxanes that can be encountered in biogas streams include but are not limited to: hexamethyldisiloxane (L2); octamethyltrisiloxane (L3); decamethyltetrasiloxane (L4); hexamethylcyclotrisiloxane (D3); octamethylcyclotetrasiloxane (D4); decamethylcyclopentasiloxane (D5); dodecamethylcyclohexasiloxane (D6).

While this invention has been particularly shown and described with references to preferred embodiments thereof, it will be understood by those skilled in the art that various changes in form and details may be made therein without departing from the scope of the invention encompassed by the appended claims.

What is claimed is:

1. A system for detecting siloxanes in a gaseous stream, comprising:
a scrubber configured to remove water-soluble interferants from the gaseous stream;
an absorption spectrometer configured to measure an infrared absorption spectrum of the gaseous stream and the scrubbed gaseous stream; and
a computer configured to receive data from the absorption spectrometer and determine a concentration of one or more siloxane compounds within the gaseous stream.

2. The system of claim 1, wherein the absorption spectrometer is a Fourier Transform Infrared (FTIR) spectrometer.

3. The system of claim 1, further comprising a carbon bed for adsorbing and/or an oxidizer for oxidizing the siloxane compounds in the gaseous stream prior to analysis by the absorption spectrometer.

4. The system of claim 1, wherein the oxidizer includes a heated Metal oxide catalyst.

5. The system of claim 1, wherein the scrubber is a gas sparge into an aqueous solution.

6. The system of claim 1, further comprising a chiller to remove water vapor added by the scrubber.

7. The system of claim 1, wherein the computer is programmed to execute a regression analysis using reference spectrum and measured spectrum to derive concentrations of the siloxanes.

8. A system for quantifying siloxanes using an infrared absorption technique, the system comprising:
an aqueous scrubber that receives a raw gaseous stream and selectively removes interfering species that overlap spectrally with siloxanes;
a gas cell configured to house the gas output from the scrubber;
an infrared spectrometer arranged to obtain spectral measurements from the gas cell;
a computer programmed to execute a regression analysis using reference spectrum and measured spectrum to derive concentrations of the siloxanes.

9. A method for detecting siloxanes in a gaseous stream, the method comprising:
removing water-soluble interferants from the gaseous stream by contacting the gaseous stream with an aqueous medium; and
measuring an infrared absorption spectrum of the aqueous-scrubbed gaseous stream compared to non-scrubbed stream to determine the presence of one or more siloxane compounds.

10. The method of claim 9, wherein the biogas is measured directly, is modified by passing through aqueous scrubber to remove VOCs, is modified further by passing through a heated metal oxide catalyst, and these spectra along with the infrared calibration spectra for each siloxane are utilized to build a regression analysis to determine the concentration of each siloxane.

11. The method of claim 9, wherein the scrubbed biogas stream becomes the sample, since it contains siloxanes, methane and water.

12. The method of claim 10, wherein an oxidized biogas stream becomes the interference spectra, since it should contain the same amount of methane and water but no siloxanes.
